(19) United States
(12) Patent Application Publication
(10) Pub. No.: US 2010/0209556 A1
(43) Pub. Date: Aug. 19, 2010

(54) Creamer composition and method to deliver viable probiotic microorganisms

(76) Inventors: Stephen B. Roman, Phoenix, AZ (US); Gary S. Kehoe, Phoenix, AZ (US); Jonathon S. Cooper, Glendale, AZ (US)

Correspondence Address: TOD R NISSLE, PO BOX 55630, PHOENIX, AZ, 85078, US

(21) Appl. No.: 12/660,061

(22) Filed: Feb. 18, 2010

Related U.S. Application Data
(60) Provisional application No. 61/207,920, filed on Feb. 18, 2009.
(60) Provisional application No. 61/275,080, filed on Aug. 24, 2009.

(51) Int. Cl. A23C 13/16

(52) U.S. Cl. 426/61

(57) ABSTRACT

A creamer composition is provided for a beverage, along with a method to deliver beneficial probiotic microorganisms to an individual using a foaming creamer applied to the surface of a hot beverage via an unpressurized container.

This application claims priority on U.S. Provisional Ser. No. 61/207,920 filed Feb. 18, 2009 and U.S. Provisional Ser. No. 61/275,080 filed Aug. 24, 2009.

This application relates to coffee creamers.

More particularly, the application relates to foaming coffee creamer compositions.

If a further respect, the application pertains to a method and apparatus to deliver to an individual viable probiotic microorganisms using a coffee creamer composition that is dispensed onto hot coffee.

The use of prebiotics and probiotics in food products is well known. The delivery, however, of probiotics in coffee and other hot drinks has, at best, limited success because the excessive temperatures in hot drinks often effectively kill probiotic bacteria and other probiotic mircroorganisms.

I have discovered a new composition and method for utilizing coffee and other hot drinks to deliver viable probiotic microorganisms to an individual.

The new method includes the steps of providing a foaming liquid dairy or non-dairy coffee creamer composition that is inoculated with at least one probiotic bacteria, packing the coffee creamer composition in a non-pressurized dispenser that includes a manually operated nozzle that injects air into the coffee creamer composition as the nozzle is operated to dispense coffee creamer composition from the dispenser and out through the nozzle and produce a probiotic inoculated coffee creamer foam, providing a cup of hot coffee, operating the nozzle to dispense coffee creamer foam out of the nozzle onto the to the surface of the hot coffee, and ingesting the probiotic inoculated coffee creamer foam from the cup of hot coffee.

In another embodiment of the invention, a method is provided to deliver live probiotic microorganisms to an individual. The method includes providing a liquid dairy or non-dairy creamer composition that is inoculated with at least one probiotic bacteria; packing the coffee creamer composition in a dispenser; storing the dispenser at room temperature; providing a cup of a beverage; dispensing the creamer composition from the dispenser into the beverage; and, ingesting the probiotic inoculated beverage from the cup of beverage.

The coffee creamer compositions of the invention can also include one or more prebiotics, typically in a concentration in the range of 8.0% to 20.0% by weight of the liquid coffee creamer composition. The weight percent of prebiotic can however, range from 5% to 90% by weight of the coffee creamer composition. As used herein, when it is indicated that a component has a particular weight percent concentration in the coffee creamer composition of this invention, such refers to the coffee creamer composition in its liquid form before it is dispensed and becomes a foam. One preferred prebiotic is agave syrup produced utilizing the following process: In a powder, or dry, embodiment of the invention, the concentration of prebiotics is typically in the range of 8.0% to 20% by weight, but can range from 5% to 90% weight.
(a) Agave pulp or root base is cut into smaller pieces that can be milled. The pulp is separated from the crude syrup.
(b) The crude syrup is run through a series of carbon-activated filters and mesh screen filters to remove impurities.
(c) The filtered crude agave syrup is metered, or weighed, into a mixing vessel.
(d) The crude syrup is subjected to controlled hydrolysis to yield the desired ratio of fructose to inulin and the resulting fructose/inulin syrup is collected.
(e) Minerals, color and flavor off-notes are removed via chromatography.
(f) Water is evaporated off to further concentrate the ratio of fructose syrup to inulin to desired levels.
(g) The evaporation process is continued until the desired amount of inulin/fructose concentration is attained.
(h) High intensity sweeteners or other additives can be blended in at this point.

To produce a dry form of the natural inulin/fructose concentrate, the steps below are initiated. If only a syrup or paste is desired, the process stops at the last step above.
(i) The resulting syrup or paste concentrate is spray dried using a conventional spray dry equipment and techniques to yield a naturally sweet inulin powder.
(j) After the spray drying is completed, further additives may be added in an agglomeration method or a simple add-mix ribbon type blender.

Conventional liquid coffee creamer compositions have long had stability and shelf-life challenges. Even UHT treated creamers only have shelf lives of six to nine months with UHT and aseptic packaging. This shelf life falls short of most other beverage compositions. In addition, high fructose corn syrup and other high glycemic sweeteners have been used in coffee creamers for many years. These sweeteners impart no health benefit to the end-user and increase the sugar and calorie content of the product. When agave syrup is used in the coffee creamer of the invention, if functions as a bulking agent and sweetener, it increases shelf-life due to its osmotic pressure at higher concentrations, and it offers a healthy alternative to other bulk sweeteners. Agave syrup also has the added benefit of delivering natural fiber in the form of inulin, a prebiotic. Inulin improves gut health and feeds probiotic bacteria.

The foaming coffee creamer composition can include fats and oils that produce a desirable mouth “feel” when foamed creamer is ingested by an individual.

As used herein, probiotics comprise live microorganisms which, when administered in adequate amounts, confer a health benefit on the host. Microorganisms are tiny living organisms such as bacteria, viruses, and yeasts that can be seen only under a microscope. Some preferred probiotics utilized in the liquid coffee creamer composition of the invention comprise bacteria from the groups Lactobacillus or Bifidobacterium, although any desired probiotic can be utilized. Another preferred probiotic is GANADEN BC30 (Bacillus coagulans). This probiotic is stable and has an extended shelf-life when used both in non-refrigerated liquid coffee creamers and in powder coffee creamers. The proportion of probiotics in the liquid coffee creamer composition of the invention is in the range of 0.001% to 3% by weight. In a powder, or dry, coffe creamer composition of the invention, the proportion of probiotics is in the range of 0.001% to 3.0% by weight.

The coffee creamer composition of the invention includes less than 10% by weight protein, preferably less than 5% by weight protein. Once possible source of protein comprises amino acids found in RICE LIFE™, which is produced by Axiom Foods and contains all the protein, bran oils, vitamins, fiber, and carbohydrates found in whole, unpolished brown rice. RICE LIFE™ is produced by a patented process and includes calcium, thiamin, riboflavin, niacin, phosphorous, iron and potassium in addition to amino acids. Any other desired source of amino acids can be utilized. RICE LIFE™ is a non-dairy, hypoallergenic, non-fiber product. Other grain “milk” products or other protein containing products can be utilized in place of or in combination with RICE LIFE™. The proportion of RICE LIFE™ or another rice or grain milk included in the liquid coffee creamer of the invention is in the range of 0.1% to 40% by weight, and is preferably in the range of 5% to 30% by weight. In the powder, or dry, embodiment of the coffee creamer of the invention, the weight percent of RICE LIFE™ or other grain milk is in the range of 0.1% to 40% by weight, preferably 5% to 30% by weight.

As used herein a foam booster is a composition that strengthens the surface tension of bubbles to make the bubbles last longer. One advantage of RICE LIFE™ is that the amino acids help the coffee creamer composition of the invention foam. The liquid coffee creamer composition of the invention includes less than 10% by weight, preferably less than 5% by weight, and most preferably less than 3% by weight of foam builder compositions. Presently preferred foam builders comprise, without limitation, sodium steroyl lactylate, sodium casseinate, guar gum, and xanthan gum. In the powder, or dry, form of the invention, foam builders don't contribute much to the production of foam when the dry form is added directly to coffee, but do function to contribute to whitening coffee, to body, and to mouth feel.

The liquid coffee creamer composition of the invention can include an emulsifier(s) in the proportion of 0.25% to 5.0% by weight. The powder, or dry, embodiment of the coffee creamer composition of the invention preferably includes an emulsifier in the proportion of 025% to 5.0% by weight. Examples of emulsifiers are mono and diglycerides, and partially hydrogenated cotton or soybean oil.

The liquid coffee creamer composition of the invention can include a bulking agent(s) (fillers) in the proportion of 40% to 99.5% by weight. The powder, or dry, embodiment of the coffee creamer composition of the invention preferably includes a bulking agent(s) in the proportion of 60% to 99.8% by weight. Examples of bulking agents in the liquid are bioagave and water. In the dry form examples of bulking agents are the agave sweetener in its dried form, maltodextrin, starches, corn syrup solids.

The liquid coffee creamer composition of the invention can include a bulk sweetener(s) in the proportion of 5% to 80% by weight. The powder, or dry, embodiment of the coffee creamer composition of the invention preferably includes a bulk sweetener(s) in the proportion of 2% to 99.9% by weight. Examples of bulk sweetener(s) in the liquid form are agave syrup, corn syrup, corn syrup solids, and sugar. Examples of bulk sweeteners(s) in the powder form agave syrup solids, corn syrup solids, and sugar.

Additional optional ingredients in the coffee creamer composition of the invention include vitamins, minerals, milk solids, buffers, thickeners, processing aids, and flavorants.

The pH of the liquid or dry coffee creamer composition of the invention is in the range of 3.5 to 10.6 and preferably is in the range of pH 5.5 to 8.5. The viscosity of the liquid coffee creamer composition is in the range of 2 to 20,000 cps and is preferably in the range of 200 to 5500 cps.

The coffee creamer composition of the invention can be added to any desired beverage or food product, but is intentionally designed for use with coffee or other beverages that are served hot.

In one preferred embodiment of the invention, liquid coffee creamer that includes living probiotics is packaged in a food grade dispenser that includes a manually operated “foaming” nozzle. When the nozzle is manually operated, it injects air into liquid coffee creamer passing through the nozzle. This facilitates the production of foam without requiring the use of a pressurized dispenser, although a pressurized dispenser can, if desired, be utilized. The nozzle functions to increase the surface area of liquid that is exposed to air. The nozzle can include a section or chamber that produces. turbulent liquid flow or air/liquid mixing to facilitate the production of foam. The dispenser may or may not be refrigerated, as desired. The dispenser nozzle is then manually operated to pump liquid from the dispenser and through the nozzle, and to produce and direct foam onto the surface of hot coffee in a cup. The foam floats on the surface of the coffee. Since the foam floats, a significant percentage of probiotic microorganisms that are in the foam will survive and be introduced into the stomach of an individual who is drinking the coffee.

In one preferred embodiment of the coffee creamer of the invention, the coffee creamer includes sodium caseinate for whitening and providing body for the creamer composition.

In another preferred embodiment of the coffee creamer of the invention includes fats, oils, and lipids that are used to produce an emulsion.

In a further preferred embodiment of the coffee creamer of the invention, fats and oils and sodium caseinate are not used and titanium dioxide is used as a whitener.

In still another preferred embodiment of the coffee creamer of the invention, the prebiotic fiber comprises or includes chickory fructo oligosaccharides.

In still a further preferred embodiment of the invention, oils and fats are not utilized in the coffee creamer of the invention, and instead foam builders are utilized in combination with RICE LIFE™ or another rice milk or other source of proteins/amino acids to produce the desired foam.

The following examples are provided by way of illustration and not limitation of the invention.

### EXAMPLE I

The following ingredients are provided:

| Ingredient | Weight % | Grams |
|---|---|---|
| Water (Rev. Osmosis) | 89.47903 | 178.95806 |
| Inulin fiber (Chicory Inulin) | 8.00000 | 16.00000 |
| Carrageenan and dextrose | 0.25000 | 0.50000 |
| (Colloid 750) | | |
| Mono and di glycerides, sodium | 1.50000 | 3.00000 |
| casseinate, sodium stearoyl, | | |
| lactylate, modified food starch, | | |
| titanium dioxide, guar gum, | | |
| xanthan gum, carrageenan, | | |
| artificial flavor, corn syrup | | |
| solids (each at 0.01 to 0.2% | | |
| by weight) | | |
| Sucralose (Splenda (tm)) | 0.09000 | 0.18000 |
| Potassium sorbate | 0.04000 | 0.08000 |
| Flavor FS8684 (Art Hazelnut) | 0.10000 | 0.20000 |
| Flavor (Nat Milk L-13992) | 0.15000 | 0.50000 |
| Thiamine hydrochloride | 0.00074 | 0.00148 |
| (B1 @ 25% RDA) | | |
| Pyridoxine HCL (B6) | 0.01850 | 0.03700 |
| Cyanocobalamin (B12) | 0.00083 | 0.00166 |
| D alpha tocopheryl acetate | 0.11000 | 0.22000 |
| (E @ 100% RDA) | | |
| Niacin (B3 @ 25% RDA) | 0.00930 | 0.01860 |
| D3 (D @ 10% RDA) | 0.00060 | 0.00120 |
| Folic Acid (50% RDA) | 0.00100 | 0.00200 |
| TOTALS | 100.00 | 200.00 |

### Manufacturing Procedure:

Heat the water to 65 degrees C., mix in at low shear the inulin, carrageenan, potassium sorbate, and sucralose in that order. Then cool the resulting composition to 55 degrees C. and mix in the mono and diglycerides, etc. and vitamins, using medium shear mixing, and allow the composition to continue to cool. When the temperature of the composition reaches 35 degrees C., add the flavorants and use high shear mixing for five to ten minutes.

### EXAMPLE II

Hazelnut; 1% BioAgave

The following ingredients are provided:

| Ingredient | Weight % | Grams |
|---|---|---|
| Water (Rev. Osmosis) | 78.73 | 747.1477 |
| Inulin fiber (Chicory Inulin) | 4.9 | 46.501 |
| Rice Life (Axiom Foods) (contains | 2.00 | 18.98 |
| All protein, bran oils, vitamins, fiber, | | |
| and carbohydrates found in whole, | | |
| unpolished brown rice; produce by | | |
| patented process; includes calcium, | | |
| thiamin, riboflavin, niacin, | | |
| phosphorous, iron and potassium | | |
| and amino acids) | | |
| Bioagave (GTC Nutrition)(Agave | 1.00 | 9.49 |
| syrup) | | |
| Alcolec EM (Am. Lec. Co.) (lethicin- | 1.00 | 9.49 |
| natural emulsifier) | | |
| Sodium caseinate | 0.50 | 4.745 |
| Flavor (Ungerer) (Art. Hazelnut | 0.4 | 3.796 |
| FS 8684) | | |
| Flavor (Mission)(Nat Milk L-13992) | 0.35000 | 3.3215 |
| Carrageenan and dextrose | 0.25000 | 2.3725 |
| (TPC Gum)(Colloid 750) | | |
| Titanium dioxide | 0.18 | 1.7082 |
| Kelcogel HM-B (CP Kelco) | 0.14 | 1.3286 |
| (colloid to suspend particles | | |
| has thixotropic like properties) | | |
| Di potassium phosphate | 0.1 | 0.949 |
| Sucralose (Splenda (tm)) | 0.05000 | 0.4745 |
| Flavor (Ungerer)(Natural Ripe | 0.05000 | 0.4745 |
| Banana FS 8594) | | |
| Pyridoxine HCL (B6) | 0.0185 | 0.175565 |
| Niacin (B3 @ 25% RDA) | 0.00930 | 0.088257 |
| Folic Acid (50% RDA) | 0.00100 | 0.00949 |
| Cyanocobalamin (B12) | 0.00083 | 0.0078767 |
| Thiamine hydrochloride | 0.00074 | 0.0070226 |
| (B1 @ 25% RDA) | | |
| D alpha tocopheryl acetate | 0 | 0 |
| (E @ 100% RDA) | | |
| D3 (D @ 10% RDA) | 0.00060 | 0.005694 |
| Potassium sorbate (0.04%) | 0 | 0 |
| TOTALS | 100.00 | 949.00 |

### Manufacturing Procedure:

Heat the water to 65 degrees C., mix in at low shear mix the inulin, carrageenan, sucralose, and HM-B in that order. Then cool to 55 degrees C., mix in the Rice Life, bioagave, Alotec EM, sodium casseinate, titanium dioxide, di potassium phosphate, and vitamins, using medium shear mixing and allow the composition to continue to cool. When the temperature of the composition reaches 35 degrees C., add the flavorants and use high shear mixing for five to ten minutes.

### EXAMPLE III

The following ingredients are provided:

| Ingredient | Weight % | Grams |
|---|---|---|
| Water (Rev. Osmosis) | 78.73 | 833.7507 |
| Bioagave (GTC Nutrition)(Agave | 20.00 | 211.8 |
| syrup) | | |
| Kelcogel HM-B (CP Kelco) | 0.07 | 0.7413 |
| Titanium dioxide | 0.18 | 1.9062 |
| Sucralose (Splenda (tm)) | 0.03000 | 0.3177 |
| Potassium sorbate | 0.04 | 0.4236 |
| Flavor (Nat. French Vanilla) | 0.3000 | 3.177 |
| Custom Dairy Blend (Flavorant) | 0.072 | 0.76248 |
| Flavor (Nat Milk L-13992) | 0.33 | 3.4947 |
| (Mission Flavors) | | |
| Pyridoxine HCL (B6) | 0.0185 | 0.195915 |
| Thiamine hydrochloride | 0.00074 | 0.007837 |
| (B1 @ 25% RDA) | | |
| Cyanocobalamin (B12)(1%) | 0.00083 | 0.00879 |
| D alpha tocopheryl acetate | 0.22 | 2.3298 |
| (E @ 100% RDA) | | |
| Niacin (B3 @ 25% RDA) | 0.00930 | 0.098487 |
| D3 (D @ 10% RDA) | 0.00060 | 0.006354 |
| Folic Acid (50% RDA) | 0.00100 | 0.01059 |
| TOTALS | 100.00 | 995.0 |

### Manufacturing Procedure:

Heat the water to 65 degrees C., mix in at low shear mixing the sucralose,and Kelcogel HM-B in that order. Then cool the composition to 55 degrees C., and mix in the bioagave, sodium caseinate, titanium dioxide, potassium sorbate, and vitamins, using medium shear mixing, and allow the composition to continue to cool. When the temperature of the composition reaches 35 degrees C., add the flavorants and use high shear mixing for five to ten minutes.

### EXAMPLE IV

The following ingredients are provided:

| Ingredient | Weight % | Grams |
|---|---|---|
| Water (Rev. Osmosis) | 78.89 | 833.7507 |
| Bioagave (GTC Nutrition)(Agave | 20.00 | 211.8 |
| syrup) | | |
| Kelcogel HM-B (CP Kelco) | 0.07 | 0.7413 |
| Titanium dioxide | 0.18 | 1.9062 |
| Sucralose (Splenda (tm)) | 0.030 | 0.3177 |
| Potassium sorbate | 0.04 | 0.4236 |
| Flavor (Art Hazelnut) | 0.219 | 2.31921 |
| Custom Dairy Blend | 0 | 0 |
| Flavor (Nat Milk L-13992) | 0.324 | 3.43116 |
| Pyridoxine HCL (B6) | 0.0185 | 0.195915 |
| Thiamine hydrochloride | 0.00074 | 0.007837 |
| (B1 @ 25% RDA) | | |
| Cyanocobalamin (B12)(1%) | 0.00083 | 0.00879 |
| D alpha tocopheryl acetate | 0.22 | 2.3298 |
| (E @ 100% RDA) | | |
| Niacin (B3 @ 25% RDA) | 0.00930 | 0.098487 |
| D3 (D @ 10% RDA) | 0.00060 | 0.006354 |
| Folic Acid (50% RDA) | 0.00100 | 0.01059 |
| TOTALS | 100.00 | 995.0 |

### Manufacturing Procedure:

Heat the water to 65 degrees C., mix in at low shear mixing the sucralose, Kelcogel, and Kelcogel HM-B in that order. Then cool the composition to 55 degrees C., and mix in the bioagave, titanium dioxide, potassium sorbate, and vitamins, using medium shear mixing, and allow the composition to continue to cool. When the temperature of the composition reaches 35 degrees C., add the flavorants and use high shear mixing for five to ten minutes.

### EXAMPLE V

The following ingredients are provided:

| Ingredient | Weight % | Grams |
|---|---|---|
| Water (Rev. Osmosis) | 58.73 | 621.9507 |
| Bioagave (GTC Nutrition)(Agave | 40.00 | 423.6 |
| syrup) | | |
| Kelcogel HM-B (CP Kelco) | 0.07 | 0.7413 |
| Titanium dioxide | 0.18 | 1.9062 |
| Sucralose (Splenda (tm)) | 0.030 | 0.3177 |
| Potassium sorbate | 0.04 | 0.4236 |
| Flavor (Nat. French Vanilla) | 0.30 | 3.177 |
| Custom Dairy Blend | 0.072 | 0.76248 |
| Flavor (Nat Milk L-13992) | 0.33 | 3.4947 |
| Pyridoxine HCL (B6) | 0.0185 | 0.195915 |
| Thiamine hydrochloride | 0.00074 | 0.007837 |
| (B1 @ 25% RDA) | | |
| Cyanocobalamin (B12)(1%) | 0.00083 | 0.00879 |
| D alpha tocopheryl acetate | 0.22 | 2.3298 |
| (E @ 100% RDA) | | |
| Niacin (B3 @ 25% RDA) | 0.00930 | 0.098487 |
| D3 (D @ 10% RDA) | 0.00060 | 0.006354 |
| Folic Acid (50% RDA) | 0.00100 | 0.01059 |
| TOTALS | 100.00 | 1059.0 |

### Manufacturing Procedure:

Heat the water to 65 degrees C., mix in at low shear mix the sucralose, and Kelcogel HM-B in that order. Then allow the composition to cool to 55 degrees C., and mix in the bioagave, titanium dioxide, potassium sorbate, and vitamins, using medium shear mixing, and allow the composition to continue to cool. When the temperature of the composition reaches 35 degrees C., add the flavorants and use high shear mixing for five to ten minutes.

### EXAMPLE VI

The following ingredients are provided:

| Ingredient | Weight % | Grams |
|---|---|---|
| Water (Rev. Osmosis) | 58.73 | 621.9507 |
| Bioagave (GTC Nutrition)(Agave | 40.00 | 423.6 |
| syrup) | | |
| Kelcogel HM-B (CP Kelco) | 0.07 | 0.7413 |
| Titanium dioxide | 0.18 | 1.9062 |
| Sucralose (Splenda (tm)) | 0.030 | 0.3177 |
| Potassium sorbate | 0.04 | 0.4236 |
| Flavor (Art Hazelnut F) | 0.219 | 2.31921 |
| Custom Dairy Blend | 0 | 0 |
| Flavor (Nat Milk L-13992) | 0.324 | 3.43116 |
| Pyridoxine HCL (B6) | 0.0185 | 0.195915 |
| Thiamine hydrochloride | 0.00074 | 0.007837 |
| (B1 @ 25% RDA) | | |
| Cyanocobalamin (B12)(1%) | 0.00083 | 0.00879 |
| D alpha tocopheryl acetate | 0.22 | 2.3298 |
| (E @ 100% RDA) | | |
| Niacin (B3 @ 25% RDA) | 0.00930 | 0.098487 |
| D3 (D @ 10% RDA) | 0.00060 | 0.006354 |
| Folic Acid (50% RDA) | 0.00100 | 0.01059 |
| TOTALS | 100.00 | 1057.348 |

### Manufacturing Procedure:

Heat the water to 65 degrees C., mix in at low shear mixing the sucralose and Kelcogel HM-B in that order. Then cool the composition to 55 degrees C., and mix in the bioagave, titanium dioxide, potassium sorbate, and vitamins, using medium shear mixing, and allow the composition to continue to cool. When the temperature of the composition reaches 35 degrees C., add the flavorants and use high shear mixing for five to ten minutes.

### EXAMPLE VII

French Vanilla; 4% BioAgave

The following ingredients are provided:

| Ingredient | Weight % | Grams |
|---|---|---|
| Water (Rev. Osmosis) | 78.73 | 747.1477 |
| Bioagave (GTC Nutrition)(Agave | 3.5 | 33.215 |
| syrup) | | |
| Kelcogel HM-B (CP Kelco) | 0.14 | 1.3286 |
| Sodium casseinate | 0.50 | 4.745 |
| Rice Life (Axiom Foods) (contains | 2.00 | 18.98 |
| All protein, bran oils, vitamins, fiber, | | |
| and carbohydrates found in whole, | | |
| unpolished brown rice; produce by | | |
| patented process; includes calcium, | | |
| thiamin, riboflavin, niacin, | | |
| phosphorous, iron and potassium | | |
| and amino acids | | |
| Inulin fiber (Chicory Inulin) | 3.15 | 29.895 |
| Alcolec EM (Am. Lec. Co.) | 1.00 | 9.49 |
| Di potassium phosphate | 0.1 | 0.949 |
| Titanium dioxide | 0.18 | 1.7082 |
| Carrageenan and dextrose | 0.25 | 2.3725 |
| (TPC Gum)(Colloid 750) | | |
| Sucralose (Splenda (tm)) | 0.05000 | 0.4745 |
| Potassium sorbate (0.04%) | 0 | 0 |
| Flavor (Nat. French Vanilla) | 0.3 | 2.847 |
| Custom Dairy Blend | 0.072 | 0.68328 |
| Flavor (Mission)(Nat Milk L-13992) | 0.33 | 3.1317 |
| Pyridoxine HCL (B6) | 0.0185 | 0.175565 |
| Thiamine hydrochloride | 0.00074 | 0.0070226 |
| (B1 @ 25% RDA) | | |
| Cyanocobalamin (B12) | 0.00083 | 0.0078767 |
| Niacin (B3 @ 25% RDA) | 0.00930 | 0.088257 |
| D3 (D @ 10% RDA) | 0.00060 | 0.005694 |
| Folic Acid (50% RDA) | 0.00100 | 0.00949 |
| TOTALS | 100.00 | 949.00 |

### Manufacturing Procedure:

Heat the water to 65 degrees C., mix in at low shear the inulin, carrageenan, potassium sorbate, and sucralose in that order. Then cool the composition to 55 degrees C. and mix in the di potassium phosphate, Alotech EM, Rice Life, sodium caseinate, titanium dioxide, and vitamins, using medium shear mixing, and allow the composition to continue to cool. When the temperature of the composition reaches 35 degrees C., add the flavorants and use high shear mixing for five to ten minutes.

### EXAMPLE VIII

EXAMPLE I is repeated except that one percent by weight of water is eliminated and in its place one percent by weight of the viable probiotic Lactobacillus acidophilus bacteria is utilized. The bacteria is added last, after the temperature of the composition is less than 30 degrees C. Similar results are obtained. The resulting composition is refrigerated.

### EXAMPLE IX

EXAMPLE II is repeated except that one percent by weight of water is eliminated and in its place one percent by weight of the viable probiotic Bifidobacterium bifidus is utilized. The bacteria is added last, after the temperature of the composition is less than 30 degrees C. Similar results are obtained. The resulting composition is refrigerated.

### EXAMPLE X

EXAMPLE III is repeated except that 0.25% percent by weight of water is eliminated and in its place one percent by weight of the viable probiotic GANADEN BC30 (Bacillus coagulans) is utilized. The bacteria is added last, after the temperature of the composition is less than 30 degrees C. Similar results are obtained.

### EXAMPLE XI

EXAMPLE IV is repeated except that one percent by weight of water is eliminated and in its place one percent by weight of the viable probiotic Lactobacillus acidophilus is utilized. The bacteria is added last, after the temperature of the composition is less than 30 degrees C. Similar results are obtained. The resulting composition is refrigerated.

### EXAMPLE XII

EXAMPLE V is repeated except that one percent by weight of water is eliminated and in its place 0.75% percent by weight of the viable probiotic Bifidobacterium bifidus is utilized. The bacteria is added last, after the temperature of the composition is less than 30 degrees C. Similar results are obtained. The resulting composition is refrigerated.

### EXAMPLE XIII

EXAMPLE VI is repeated except that one percent by weight of water is eliminated and in its place 0.25% percent by weight of the viable probiotic GANADEN BC30 (Bacillus coapulans) is utilized. The bacteria is added last, after the temperature of the composition is less than 30 degrees C. Similar results are obtained.

### EXAMPLE XIV

EXAMPLE VII is repeated except that one percent by weight of water is eliminated and in its place one percent by weight of the viable probiotic Bifidobacterium bifidus is utilized. The bacteria is added last, after the temperature of the composition is less than 30 degrees C. Similar results are obtained. The resulting composition is refrigerated.

### EXAMPLE XV

The liquid coffee creamer of Example I is placed in a non-pressurized dispenser. The creamer contents of the dispenser are not pressurized in the dispenser. The dispenser includes a manually operated foaming spray nozzle that produces a foam by injecting air into the coffee creamer as it is dispensed through the nozzle. Coffee is provided in a Styrofoam cup. The temperature of the coffee is one hundred and ninety degrees F. The spray nozzle on the dispenser is operated to dispense a layer of creamer foam about one-half inch high onto the coffee. The foam floats on the surface of the hot coffee. After ten minutes foam still exists on the surface of the hot coffee.

### EXAMPLE XVI

The liquid coffee creamer of Example VIII is placed in a dispenser. The creamer includes viable probiotic Lactobacillus acidophilus bacteria. The creamer contents of the dispenser are not pressurized in the dispenser. The dispenser is placed in a refrigerator. The dispenser includes a manually operated foaming spray nozzle that produces a foam by injecting air into the coffee creamer as it is dispensed through the nozzle. The dispenser is removed from the refrigerator. The nozzle is operated to dispense a foam sample from the dispenser. The foam sample is analyzed to confirm that the foam contains viable bacteria. The foam contains viable bacteria. Coffee is provided in a Styrofoam cup. The temperature of the coffee is one hundred and ninety degrees F. The spray nozzle on the dispenser is operated to dispense a layer of creamer foam about one-half inch high onto the coffee. The foam floats on the coffee. After five minutes the foam floating on the coffee is analyzed to determine if there are viable probiotic Lactobacillus acidophilus bacteria in the foam. Viable bacteria are in the foam.

### EXAMPLE XVII

EXAMPLE XVI is repeated except that after ten minutes the foam floating on the coffee is analyzed to determine if there are viable probiotic Lactobacillus acidophilus bacteria in the foam. Viable bacteria are in the foam.

### EXAMPLE XVIII

EXAMPLE XVI is repeated except that the foam is stirred into the coffee as soon as it is dispensed onto the top of the coffee. After five minutes the coffee is analyzed to determine if there are viable probiotic Lactobacillus acidophilus bacteria in the coffee. There are no viable bacteria in the coffee.

### EXAMPLE XIX

EXAMPLE XVI is repeated except that the foam is stirred into the coffee as soon as it is dispensed onto the top of the coffee. After ten minutes the coffee is analyzed to determine if there are viable probiotic Lactobacillus acidophilus bacteria in the coffee. There are no viable bacteria in the coffee.

### EXAMPLE XX

EXAMPLES XVI to XIX are repeated, except that the coffee creamer of EXAMPLE IX is utilized, which creamer includes viable probiotic Bifidobacterium bifidus bacteria. Similar results are obtained.

### EXAMPLE XXI

EXAMPLES XVI to XIX are repeated, except that (1) the coffee creamer of EXAMPLE X is utilized, which creamer includes viable probiotic GANADEN BC30 (Bacillus coagulans) bacteria, and (2) the dispenser is not refrigerated but is maintained at room temperature. Similar results are obtained, except that when the foam is admixed into the coffee and coffee is tested for viable bacteria after five and ten minutes there are viable bacteria in the coffee, and the majority of viable bacteria that were originally admixed into the coffee have survived.

### EXAMPLE XXII

Example V is repeated except that only 40% by weight water is utilized, and 20% by weight inulin fiber (Chickory inulin) is added to the composition. The inulin is added during the first step of the process when the water is heated to 65 degrees C. After all of the components are admixed and the temperature of the resulting composition is 35 degrees C., then the resulting composition is spray dried. The resulting powder is agglomerized in an agglomeration mixer comprising a rotating drum. Ganaden BC30 probiotic and flavorants are sprayed onto the powder as the drum turns. The resulting agglomerized power mixture is dried on a fluidized bed.

Having described the invention in such terms as to enable those skilled in the art to understand and practice it, and having described the presently preferred embodiments thereof,

We claim:

1. A method to deliver live probiotic microorganisms to an individual, comprising the steps,
(a) providing a foaming liquid dairy or non-dairy coffee creamer composition that is inoculated with at least one probiotic bacteria;
(b) packing said coffee creamer composition in a non-pressurized dispenser that includes a manually operated nozzle that injects air into the coffee creamer composition as the nozzle is operated to dispense coffee creamer composition from the dispenser and out through the nozzle and produce a probiotic inoculated coffee creamer foam;
(c) providing a cup of hot coffee;
(d) operating the nozzle to dispense coffee creamer foam out of the nozzle onto the to the surface of the hot coffee; and,
(e) ingesting the probiotic inoculated coffee creamer foam.

2. A method to deliver live probiotic microorganisms to an individual, comprising the steps,
(a) providing a liquid dairy or non-dairy creamer composition that is inoculated with at least one live probiotic bacteria;
(b) packing said coffee creamer composition in a dispenser;
(c) storing said dispenser at room temperature;
(d) providing a cup of a beverage;
(e) dispensing said creamer composition from said dispenser into the beverage along with live probiotic bacteria in said creamer composition; and,
(f) ingesting the live probiotic inoculated beverage.
